(19) United States
(12) Patent Application Publication
(10) Pub. No.: US 2012/0232926 A1
(43) Pub. Date: Sep. 13, 2012

(54) SYSTEM AND METHOD FOR PREDICTION OF PATIENT ADMISSION RATES

(76) Inventors: Justin Boyle, Herston (AU); Derek Ireland, Herston (AU)

(21) Appl. No.: 13/384,285

(22) PCT Filed: Jul. 14, 2010
(86) PCT No.: PCT/AU2010/000891

§ 371 Date: May 23, 2012

(30) Foreign Application Priority Data
Jul. 16, 2009 (AU) 2009202874

(51) Int. Cl. G06Q 10/04; G06Q 50/24

(52) U.S. Cl. 705/3

(57) ABSTRACT

An automated method, as well as computer-implemented systems, apparatus and software products, to predict patient demand in a medical facility. A database contains historical data of patient demand during one or more past time periods. At least two distinguishing characteristics are associated (202) with a specified time period of interest, the first characterising a day within which the time period occurs, and the second characterising a timeframe within which the day occurs. Corresponding historical data is extracted (204) having equivalent distinguishing characteristics. A computational predictive model is applied (206) to the extracted data, to generate a prediction of patient demand. The predicted demand is output (208), for example to a suitable visual display. The invention may be applied, for example, to improve the efficiency of operations in medical facility emergency departments.

### FIELD OF THE INVENTION

The present invention relates generally to the management of patients presenting for treatment, including emergency treatment, at medical facilities, and more particularly to a method, system and computer program product for predicting demand, such as expected presentation and admission rates.

### BACKGROUND OF THE INVENTION

Overcrowding at emergency departments of medical facilities, such as hospitals, is a recognised problem worldwide. It is advantageous, in order to better cater for the numbers of people presenting to an emergency department, to be able to predict in advance the likely number of presentations and admissions. Such predictions would enable the management of resources, such as emergency department staff and facilities, to be improved, in order to provide a better, safer and more efficient service.

A primary cause of overcrowding in emergency departments is the practice of “boarding”, which is the holding of patients admitted to a hospital within the emergency department. Recent recommendations made by the American College of Emergency Physicians (ACEP), in the 2009 National Report Card on the State of Emergency Medicine, identified a number of practices that would be effective in reducing boarding, and improving the flow of patients through emergency departments. Two of the highest-impact solutions are to coordinate the discharge of hospital patients before noon, and to coordinate the scheduling of elective patients and surgical patients. Such coordination would be greatly assisted if accurate predictions of demand for emergency department facilities were available. However, due in part to a lack of effective and easily implemented predictive tools, many hospitals still do not anticipate and prepare for upcoming volume and admission of patients through the emergency department.

Overcrowding of emergency departments has a number of significant detrimental implications. For example, impaired function of the emergency department may result in an increase in ambulance bypass occurrences, and less-favourable outcomes for patients, including increased mortality associated with patients whose access to emergency facilities is blocked or otherwise reduced. Access block may also result in last-minute cancellation of elective surgical patients, with resultant inflating of elective waiting lists on which patients spend increasing time. Endemic and critical access block has been identified as a serious threat to patient safety.

A number of studies involving the analysis and modelling of emergency department information have been conducted in the prior art. Some of these have focused upon predicting whether or not emergency department overcrowding will occur during a specified time period (eg one hour into the future), ie a binary outcome which is indicative of the likelihood of ambulance diversion. Such models are useful for short-term management of emergency department facilities, but do not enable planning and management of resources over one or more upcoming days of operation. Related work has involved attempting to predict hourly emergency department presentations. Again, such predictions do not assist longer-term planning.

Other work in the prior art relating to the prediction of emergency department demand has utilised recent past historical information, such as recorded demand over a number of preceding days, weeks or months, in order to estimate likely future demand. Various forecasting models have been employed, with varying degrees of success.

However, it remains desirable to develop improved modelling and forecasting techniques for predicting patient demand, and it is accordingly an object of the present invention to make more effective use of available historical information, and appropriate modelling and forecasting techniques, in order to generate predictions of demand that are more accurate and reliable, over longer forecast horizons, than prior art methods. It is also considered highly desirable that a predictive tool be provided in the form of an easily usable software package that can be used by emergency department administrators and clinicians for effective and efficient resource management, in order to improve the functioning of an emergency department, resulting in more-favourable outcomes for patients, and other improvements to the overall operation of medical facilities.

### SUMMARY OF THE INVENTION

In accordance with one aspect of the present invention, there is provided an automated method of predicting patient demand in a medical facility during a specified time period, the method including the steps of:

providing a database containing historical data of patient demand during one or more past time periods;

associating with the specified time period at least two distinguishing characteristics, wherein a first distinguishing characteristic characterises a day within which the specified time period occurs, and a second distinguishing characteristic relates to a timeframe within which the day occurs;

extracting from the database historical patient demand data corresponding with past time periods having distinguishing characteristics equivalent to those associated with the specified time period;

applying a computational predictive model to the extracted data, to generate a prediction of patient demand during the specified time period; and

outputting the prediction of patient demand to a visual display unit, a file and/or another output device.

While embodiments of the invention are particularly useful for predicting patient demand in emergency departments, the method may be applied to forecast demand in other areas of medical facility operations in order to improve overall management of resources, leading to more-favourable patient outcomes.

Advantageously, embodiments of the invention seek to make better use of available historical data of patient demand in order to provide improved predictions. It is, in particular, an insight of the present inventors that past time periods sharing common characteristics with the specified time period for prediction may provide a better basis for predictive modelling than projections based primarily upon recent trends. While it has previously been observed that demand tends to depend upon the day of the week (eg there may be a greater number of presentations at emergency departments during the weekend, or on Mondays), by characterising the time period for which a prediction is required using additional distinguishing characteristics, it is anticipated that improved predictive performance may be achieved.

In accordance with a preferred embodiment of the invention, the first distinguishing characteristic is a day type, which distinguishes at least between different days of the week. More preferably, the day type further distinguishes days which are public holidays in the locality of the medical facility. It has been found also to be advantageous that the day type further distinguishes days immediately preceding and/or following publica holidays in the locality of the medical facility. Studies conducted by the present inventors have demonstrated that taking all of these factors into account in characterising the day within which a prediction is required, improved predictive accuracy may be achieved.

In some embodiments, the second distinguishing characteristic is a month of the year within which the day occurs. Accordingly, for example, if the specified time period for prediction falls upon a Tuesday in July, then historical patient demand data will be extracted from the database corresponding with all Tuesdays in July over all years included in the historical data. Other exemplary combinations of distinguishing characteristics would be “all public holidays in December”, or “all days following a public holiday in April”.

In another embodiment, the second distinguishing characteristic is a predetermined time period surrounding the date on which the specified time period occurs, within each available year of the historical data. For example the predetermined time period may be a period of four weeks centred on the date on which the specified time period for prediction occurs. Historical patient demand data will accordingly be extracted for all matching day types (eg Tuesdays, public holidays, days following public holidays, and so forth) within this same time period for each year of available historical data.

Advantageously, embodiments of the invention accordingly seek to base a prediction of patient demand during the specified time period upon historical demand within time periods that are, in a relevant sense, most directly comparable with the time period of interest.

The computational predictive model may be one of: a multiple regression model; an Autoregressive Integrated Moving Average (ARIMA/Box-Jenkins) model; an exponential smoothing model; a uniform averaging model; and a weighted averaging model. The choice of computational predictive model may be based upon experience and/or experimental data used to identify which predictive model is most effective in combination with the selected distinguishing characteristics and/or available historical patient demand data. For example, in studies conducted by the present inventors, it has been found that an averaging model is most effective when a large quantity of historical patient demand data is available (eg over a number of years), whereas a regression model may be more effective when only limited historical patient demand data (eg over one year) is available. It will be appreciated that various computational predictive models are available, and the foregoing list of preferred model types is exemplary only.

Preferably, the prediction of patient demand includes a prediction of patient presentations. Advantageously, the prediction of patient demand may include a prediction of patient admissions. It is notable that while prior art methods have proven to be reasonably effective in predicting patient presentations, studies conducted by the present inventors have demonstrated that embodiments of the invention are particularly distinguished by an ability to provide improved predictions of actual admission rates.

In preferred embodiments, the prediction of patient demand includes upper- and lower-bounds of predicted patient demand at a predetermined confidence level. Thus, for example, a prediction may include an expected number of patient presentations and/or admissions during the specified time period, along with a surrounding range representing, eg the possible actual numbers of patients anticipated with eg 95 percent confidence. The particular confidence level employed may be specified by a user, in the case of a software implementation of the inventive method, and generally the higher level of confidence required, the broader will be the range of predicted demand encompassed by the upper- and lower-bounds.

Advantageously, the prediction of patient demand may include a prediction of demand by patients in one or more sub-categories. For example, sub-categories may include patient gender and/or patient criticality. Accordingly, embodiments of the invention may be used, for example, to predict not only overall patient presentations and/or admissions, but also the numbers of male and/or female patients, and the number of patients in each one of a number of triage categories. Further sub-categories may include categories of admission type, such as orthopaedic, paediatric and cardiac admissions, for example.

The historical data preferably includes historical data of patient demand at the medical facility for which a prediction of patient demand is required. However, the historical data may also, or alternatively, include historical data of patient demand at one or more other medical facilities. It is a surprising result of studies conducted by the present inventors, that information relating to patient demand at a different medical facility, when appropriately adjusted for overall demand (ie different total numbers of patients at different facilities) can result in useful predictive outcomes, at least in some circumstances. This may be indicative of the general power and effectiveness of the inventive techniques.

In another aspect, the present invention provides a computer-implemented system for predicting patient demand in a medical facility during a specified time period, the system including:

one or more processors;

a database, accessible to the processor(s), containing historical data of patient demand during one or more past time periods;

at least one output interface operatively associated with the processor(s); and

at least one storage medium containing program instructions for execution by the processor(s), said program instructions causing the processor(s) to execute the steps of:
associating with the specified time period at least two distinguishing characteristics, wherein a first distinguishing characteristic characterises a day within which the specified time period occurs, and a second distinguishing characteristic relates to a timeframe within which the day occurs;
extracting from the database historical patient demand data corresponding with past time periods having distinguishing characteristics equivalent to those associated with the specified time period;
computing a prediction of patient demand during the specified time period, using a predictive model based upon the extracted data;
outputting the prediction of patient demand via the output interface.

Preferably, the system also includes an input interface operatively associated with the processor(s), and the program instructions further cause the processor(s) to execute the steps of:

receiving, via the input interface, updates including recent patient demand data; and

adding the recent patient demand data to the historical data contained in the database.

Advantageously, therefore, embodiments of the invention are able to maintain consistently updated historical information, in order to provide ongoing predictions of patient demand.

In some implementations and/or modes of operation, the program instructions cause the processor(s) automatically to generate periodically updated predictions of patient demand. Accordingly, a system is provided which is able to operate in an unsupervised mode, providing department administrators, clinicians or other staff, with regularly updated predictions that may be used in the operation and management of the department.

In alternative embodiments and/or modes of operation, the system further includes a user input interface, operatively associated with the processor(s), whereby a user is able to enter a specified time period of interest, and the program instructions further cause the processor(s) to execute the steps of:

receiving the user-specified time period via the user input interface; and

generating a prediction of patient demand during the user-specified time period.

Such implementations may be useful where a user, such as an department administrator, clinician or other staff member, requires a prediction of demand for a particular future time period, for planning and/or management purposes.

In preferred embodiments, the output interface includes a graphical display device, and the program instructions further cause the processors to execute the steps of outputting a graphical display of predicted patient demand for one or more future time periods. Such embodiments enable “at a glance” views of anticipated upcoming patient demand.

In another aspect, the invention provides an apparatus for predicting patient demand in a medical facility during a specified time period, the apparatus including:

a database containing historical data of patient demand during one or more past time period;

means for associating with the specified time period at least two distinguishing characteristics, wherein a first distinguishing characteristic characterises a day within which the specified time period occurs, and a second distinguishing characteristic relates to a timeframe within which the day occurs;

means for extracting from the database historical patient demand data corresponding with past time period having distinguishing characteristics equivalent to those associated with the specified time period;

means for applying a computational predictive model to the extracted data to generate a prediction of patient demand during the specified time period; and

means for outputting the prediction of patient demand to a visual display unit, a file and/or other output device.

In another aspect, the invention provides a computer program product including computer-executable instructions embodied upon a tangible computer-readable medium, wherein the computer-executable instructions, when executed by a suitable computer, cause the computer to implement a method, or to embody a system or apparatus, in accordance with the invention.

Further preferred features and advantages of the present invention will be apparent to those skilled in the art from the following description of preferred embodiments of the invention, which should not be considered to be limiting of the scope of the invention as defined by any of the preceding statements, or in the claims appended hereto.

### BRIEF DESCRIPTION OF THE DRAWINGS

Preferred embodiments of the invention are described with reference to the accompanying drawings, in which like reference numerals refer to like features, and wherein:

FIG. 1 is a block diagram illustrating schematically a system embodying the present invention;

FIG. 2 is a flowchart illustrating a method of predicting patient demand in accordance with embodiments of the present invention;

FIG. 3 is a flowchart illustrating methods of predicting patient demand in accordance with exemplary embodiments of the invention;

FIGS. 4(a) and 4(b) show graphs of historical patient demand according to exemplary embodiments of the invention;

FIG. 5 shows graphs of historical patient flow according to exemplary embodiments of the invention;

FIG. 6 shows graphs comparing performance of alternative embodiments of the invention; and

FIGS. 7(a) and 7(b) illustrate graphical displays output by an exemplary computer program embodying the invention.

### DETAILED DESCRIPTION OF PREFERRED EMBODIMENTS

Embodiments of the present invention provide automated methods, computer-implemented apparatus and systems, and computer program products, for predicting patient demand in medical facilities. Preferred embodiments are described herein with reference to forecasting patient demand within emergency departments of hospitals, in which the availability of reliable advance predictions of expected demand is particularly advantageous, however the invention is applicable across a range of medical facility operations fsubject to varying patient demand rates. In particular, it is desirable to provide a computer-implemented prediction tool which is easily usable by clinical staff in relevant medical facilities, and which accurately predicts the number of patient presentations and admissions occurring during specified time periods, such as individual days of the year, and/or shorter time periods (such as single hours, or blocks of hours) within a day. The availability of forecast information of this type supports the effective management and operation of patient facilities and resources.

A computer implementation of an patient demand forecasting tool may take the form of a standalone system, eg a computer program adapted to load and execute on a single computer, for use in a single location. Such systems may be installed at all individual locations at which patient demand forecasts are required. In an alternative embodiment, however, a system for providing forecasts of patient demand is implemented using a central server computer, which may be accessed from one or more remote locations, for example via the Internet and using a conventional web browser and related technologies, such as applets and/or plug-ins. A networked implementation has the advantage of enabling the forecasting system, and associated data, to be managed and maintained at a single location, while providing access and forecasting information to any number of remote locations, as required. Preferred embodiments of the invention will therefore be described with reference to such a networked implementation, however it will be appreciated that the invention also encompasses other embodiments, including standalone implementations.

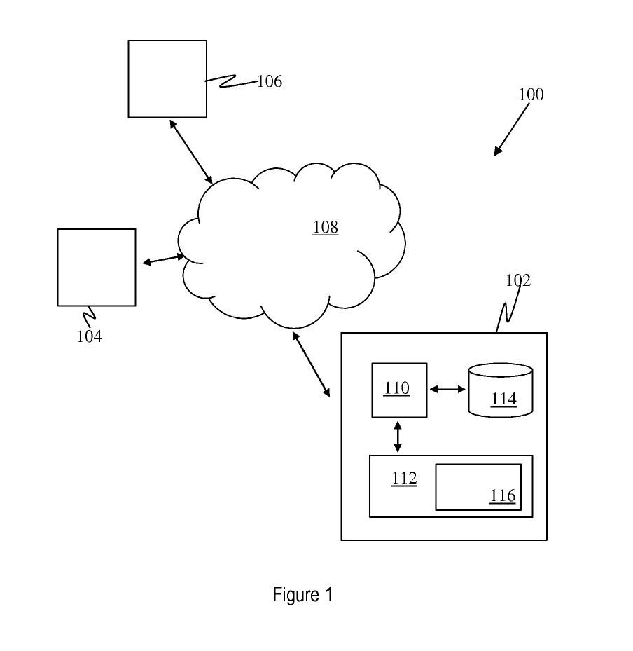

FIG. 1 is a schematic diagram representing a networked system 100 embodying the present invention. In particular, the networked system 100 includes a server computer system 102 which may be accessed from one or more user computer systems, eg 104, 106, via a computer network such as the Internet 108. In a preferred embodiment, known communication protocols (eg TCP/IP) and software applications (eg web browser software and associated plug-in components) are utilised to access the server 102 via the network 108, in a conventional manner.

In the exemplary system 100, the server 102 consists of a single computer, the configuration and operation of which is described in greater detail below. It will be appreciated, however, that this exemplary embodiment is merely the simplest implementation, and in alternative embodiments the server 102 may include multiple computers and/or processors, which may be either closely coupled, or interconnected via additional network links (not shown).

The exemplary server 102 includes at least one processor 110, which is associated with random access memory 112, used for containing program instructions and transient data related to the operation of the services provided by the server 102. The processor 110 is also operatively associated with a further storage device 114, such as one or more hard-disk drives, used for long-term storage of program components, as well as for storage of data relating to the general operation of the server 102, and implementation of an embodiment of the invention, as described in greater detail below.

At any given time, the memory 112 contains a body of program instructions 116 which, when executed by the processor 110, implement various functions of the server 102. These include general operating system functions, as well as specific functionality associated with an embodiment of the present invention.

The server 102 is provided with a database, which is accessible to the processor 110, and which contains historical data of emergency patient demand at one or more relevant medical facilities, during one or more past time periods. The database may be stored on the local storage device 114, or may be maintained on a separate data storage unit, located either locally or accessible via the network 108. The precise location and form of the database is not critical, so long as it is readily accessible to the processor 110.

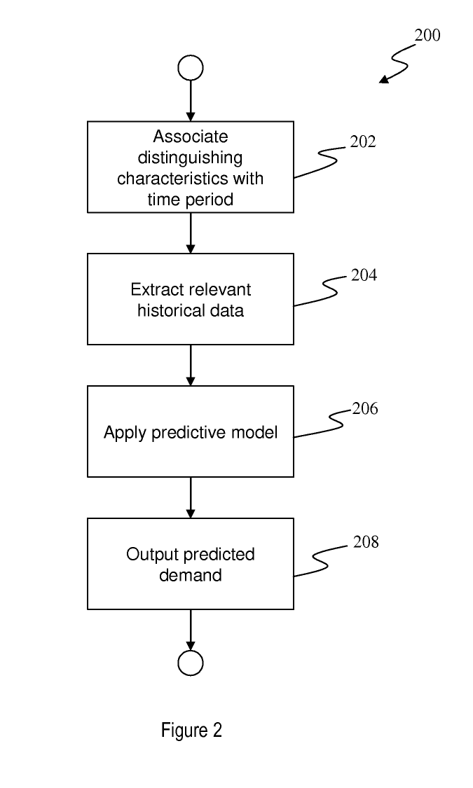

In general, embodiments of the invention operate by analysing historical patient demand data held in the database in order to provide relevant predictions of future demand during particular specified time periods. The flowchart 200 illustrated in FIG. 2 shows a method of predicting emergency patient demand in accordance with embodiments of the invention. Given a particular specified time period for which a prediction of emergency patient demand is required, at step 202 the method first associates with the specified time period at least two distinguishing characteristics, the first one of which characterises a day within which the specified time period occurs. For example, when the specified time period occurs on a specific day of the week, then the first distinguishing characteristic may represent that day of the week. However, as will be described in greater detail below, with reference to particular examples, the day during which a time period occurs may be characterised in alternative manners, such as a weekend, public holiday, or day adjacent to a public holiday. The second distinguishing characteristic associated with the specified time period relates to a timeframe within which the day occurs, such as a calendar month, or other relevant time period.

At step 204, historical patient demand data is extracted from the database, the extracted data being selected to correspond with past time periods having distinguishing characteristics equivalent to those associated with the specified time period. For example, if the two distinguishing characteristics associated with the specified time period at step 202 are that the period occurs on a Wednesday, and that it is during the month of March, then all historical data corresponding with “Wednesdays” in “March” will be extracted from the database.

At step 206 a computational predictive model is applied to the data extracted at step 204 in order to generate a prediction of emergency patient demand during the specified time period. Various predictive modelling methods are available for implementation of this step, including multiple regression models, Autoregressive Integrated Moving Average (ARIMA/Box-Jenkins) models, exponential smoothing models, uniform averaging models, and weighted averaging models. The choice of a particular computational predictive model may affect the accuracy of predictions, and the performance of a chosen model may depend upon the nature and quantity of historical data available. Accordingly, embodiments of the invention are not limited to the use of any specific computational predictive model, and it is preferred that a model be chosen in each specific implementation based upon trials and/or experience using available historical data, as illustrated in the examples below.

At step 208, a prediction of emergency patient demand is output. In the preferred embodiments described herein, the output is to a display device, most preferably in a graphical form that is easy for a clinician within the medical facility to understand and utilise as a basis for administrative and/or operational action, such as determining future staffing levels or other allocation of resources. Additionally, or alternatively, predictions of emergency patient demand may be output to one or more files (enabling future review), to hardcopy devices (eg printers), and/or to other output devices.

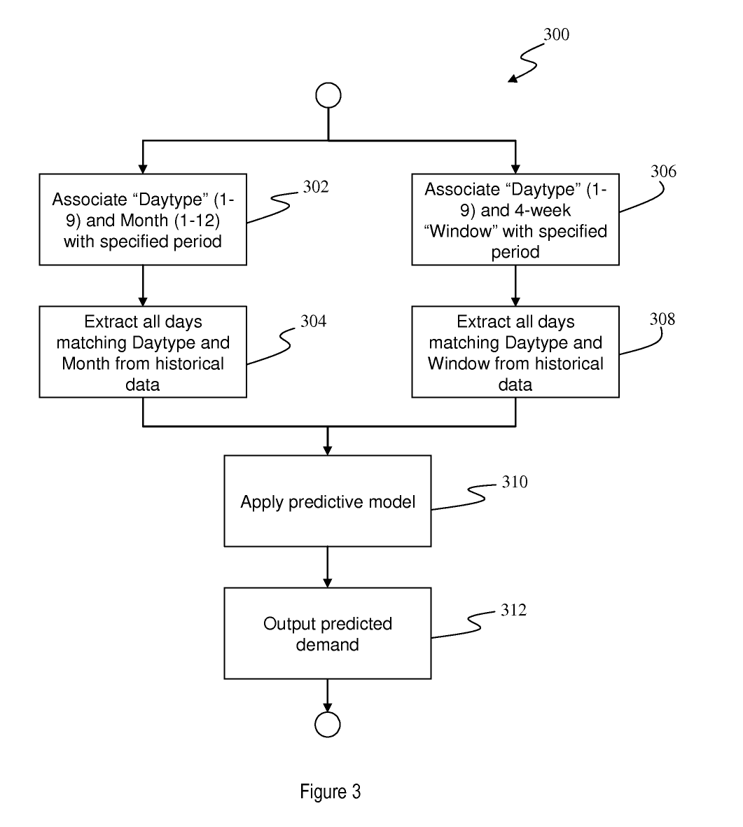

FIG. 3 is a further flowchart 300 illustrating methods of predicting emergency patient demand in accordance with exemplary embodiments of the invention, as utilised in the examples discussed in greater detail below.

In a first approach in the exemplary embodiments, at step 302 the two distinguishing characteristics associated with the specified time period are a “day type”, and a “month” corresponding with a day within which the time period occurs. The day type is conveniently represented using a single number, corresponding with a day of the week (eg Sunday to Saturday represented by the numbers “1” to “7”), while it has also been found to be advantageous to distinguish public holidays (assigned a day type of “8”) and also the days before and/or after public holidays (assigned a day type of “9”). The month is conveniently represented by the numbers “1” to “12”, for January to December.

At step 304, all days within the historical data that match the day type and month associated with the specified time period are extracted, for use as the basis for prediction. Days having matching characteristics are considered to be most “similar” to the day of interest, in terms of patient demand, and accordingly are expected to provide the best basis for prediction.

In an alternative approach, at step 306 the distinguishing characteristics associated with the specified time period again include firstly the day type, defined in the same manner as discussed above. However, the second distinguishing characteristic, rather than being a calendar month, is instead defined in terms of a time period surrounding the day of interest. In the exemplary embodiments, the surrounding time period covers a total of four weeks, centred on the day of interest, ie two weeks prior and two weeks following. (For recent historical data, during the current year, information will only be available from the preceding weeks, since the following weeks have yet to occur.) Again, at step 308, data for all days corresponding with these distinguishing characteristics is extracted from the historical database.

At step 310, a computational predictive model, such as a smoothing or averaging model, is applied to the extracted data in order to produce a prediction of patient demand for the specified time period. The computational predictive model may be adapted to apply a weighting to more recent data, for example if it is expected that more recent patient demand is likely to be a better indicator of future demand than older historical demand data. Additionally, the extracted data may be adjusted to account for factors such as population growth. In particular, the historical data may show annual increases in total patient demand, due to a growing population, and the annual growth may be used as a basis to adjust older historical figures for parity with the current population.

Finally, the calculated prediction of emergency patient demand for the specified time period is output at step 312.

While the two methods represented by the steps 302, 304 and 306, 308 respectively in the flowchart 300 are broadly similar, they have some different characteristics. The “calendar month” method (steps 302, 304) utilises full calendar month information from prior years of historical data, and up to a full calendar month from the current year. However, this method is subject to data latency, ie at the beginning of a new month the most recent relevant historical data is 11 months old. The second method, based on a “rolling time window” (steps 306, 308) always utilises a recent period of data, and is able to take advantage of regular updates to the system, but never uses more than two weeks of information from the current year.

Preferably the content of the database of historical data is regularly updated with new information. This information includes the actual numbers of presentations and admissions recorded during operation of the medical facilities, as well as any other data that is routinely gathered, such as times of presentation and admission, length-of-stay, patient gender, criticality, type of treatment required, and so forth. As with the initial body of historical data, all of this information is useful for forecasting future demand. Current data may be gathered using existing medical facility information systems, and in the embodiment 100 made available to the server 102 via a suitable input interface, such that the server is able to add the information updates to the database of historical data. Data updates may be provided, for example, on a disc (such as a CD-ROM or DVD-ROM disc), or made available for download to the server 102 via the network 108.

While the general methods employed by preferred embodiments of the invention have been described in the foregoing, with reference to FIGS. 1 to 3, the performance of such embodiments has been evaluated through trials utilising real historical emergency patient demand data available for two separate medical facilities. The nature and results of these trials, which will further assist in understanding the features and advantages of the invention, are described in the following examples.

In order to validate preferred embodiments of the invention, a trial comprising a retrospective analysis of emergency department (ED) presentations and hospital admissions was conducted using data from a five-year period between 1 Jul. 2002 and 31 Mar. 2008 from two separate hospitals. Both hospitals are located in the same general geographic region, however the first is a regional facility and the second an urban facility.

No particular age groups, admission types or other subgroups were excluded.

Quantitative data from the hospitals' health information system was provided by the Information Directorate of the relevant state health jurisdiction. Data related to patient demographics (age, gender), ED characteristics (triage category, ED length of stay, discharge destination from ED) and hospital admission characteristics (hospital length-of-stay, in-hospital mortality, discharge destination).

The 750-bed urban facility is one of the busiest ED's in the state that services a rather roving population of around 500,000 people. It is host to several annual events that attract large numbers of tourists. The 280-bed regional facility is 120 km away from a major tertiary referral centre and services an area of approximately 410,000 km² with a resident population of about 280,000. Both facilities offer paediatric and adult emergency services. Presentations numbers for both hospitals across the study period were similar, being 218,000 at the regional facility, and 278,000 at the urban facility.

The study involved the prediction of both total presentations and total admissions (those patients that require a bed and thus represent a demand on bed management). The ability to generalise the model to other hospitals was assessed by scaling predictions made for one hospital by the ratio of mean admission rates between hospitals, and comparing against actual admissions at the second hospital. Analysis also included splitting the data into gender and criticality, and determining a recommended sample size for accurate forecasting of such smaller subgroups.

All data variables were defined and de-identified data extracts were obtained from both hospital-wide and ED-specific clinical information systems. Predictive mathematical models were developed using retrospective data accounting for arrival time (eg hour of day, day of week, month of year), holidays and population factors (eg annual increase in presentations and admissions). Validation of the models was undertaken using appropriate statistical techniques, to establish the performance on samples of actual admissions and presentation data.

In this study, accuracy was treated as the main criterion for selecting a forecasting method, and the assessment of forecast accuracy was based upon Mean Absolute Percentage Error, derived as follows.

If Yₜ is the actual observation (eg of a measure of patient demand) for time period t and Fₜ is the forecast for the same period, then an error eₜ is defined as:

eₜ=Yₜ−Fₜ (1)

The Percentage Error of forecasts (PEₜ) is defined as:

$${PE}_{t} ( \frac{{Y}_{t} - {F}_{t}}{{Y}_{t}} ) \times 100. \qquad ( 5 )$$

From this relative error, the Mean Absolute Percentage Error (MAPE) used as the measure of forecast accuracy, is defined as:

$$M A P E = \frac{1}{n} {\sum }_{t = 1}^{n} \vert {PE}_{t} \vert \qquad ( 6 )$$

True out-of-sample forecast accuracy was measured in this study, where data was divided into a training set and evaluated against a separate holdout set. The evaluation dataset spanned one year (364 days), allowing accuracy to be measured across varying forecast horizons including summer and winter months. For most of the analysis, the evaluation period was the 12 months between July 2006 and June 2007, and the latest evaluation performed was across the period spanning April 2007 to March 2008. The effect of varying the size of the training dataset was analysed and training lengths of one, two, three, four and 4.3 years (July 2002 to March 2007) were assessed. Also computed were the width of 95% prediction intervals (±x admissions) and the number of misses outside this prediction interval. This provides the user of the forecasts with worst and best case estimates and a sense of how dependable the forecast is. As an outcome from the study, it was desired to compare forecasting performance against existing prediction models developed at one of the hospitals, and also against other published forecast performance.

Presentation and admission data included a time field which was used to aggregate data into hourly, 4-hourly, daily, weekly, monthly and yearly time intervals. The forecasting techniques developed in the study were modelled using the data analysis package Matlab from The MathWorks Inc (v7.2.0.232 R2006a) and algorithms were coded by hand. To gain an alternative perspective and to check the results, SPSS Trends software from SPSS Inc (v14.0.1 2005) with its Expert Modeller feature was used.

It was considered that the ED forecasting models would need to include variables for the day of week, month of year and holidays, and to identify repeated patterns in the time series data. The models considered in this study included multiple regression, Autoregressive Integrated Moving Average (ARIMA/Box-Jenkins), exponential smoothing and averaging models.

Several cases were constructed to assess the effects of varying the length of training data. For example, it was considered desirable to ascertain whether evaluation across a 12-month period up to November 2007 was any different from evaluation across 12-months up to the end of March 2008, in order was to assess the impact of the opening of a new ED wing within the catchment area of one of the hospitals.

It was also of interest to assess the applicability of predictions between hospitals, for example comparing predictions made for the regional facility against admissions observed at the urban facility. This would give an indication of whether the models could be generalised to other sites. In order to adapt the model from one facility to the other, forecasts were generated from both regression models and smoothing models and then scaled by the ratio of the mean number of daily admissions between hospitals.

The ability to predict the gender and criticality of admissions could assist with assigning appropriate wards or staff resources. Thus admissions data was partitioned into subgroups of gender and triage category and the forecast accuracy of each assessed. The triage categories ranged from patients who required resuscitation (triage category 1) to those whose medical needs are not urgent (triage category 5). Since the subgroups contain fewer historical data samples than the overall patient demand rates, it was expected that the accuracy of predictions for small subgroups would be inferior to the accuracy of overall predictions. An objective of computing predictions for subgroups was thus to estimate a sample size threshold below which there may be significantly more errors than the overall dataset. The smoothing techniques were based on assigning a code to day type (ie Sunday=1, Monday=2, . . . , Saturday=7), a separate day type (“8”) to public holidays (eg Christmas, Easter) and a separate day type (“9”) for the days immediately preceding and following the holidays. For comparison purposes, predictions were also performed treating all days as “normal” days and disregarding the effect of holidays. Thus, for example, if Christmas Day falls on a Friday, a comparison may be performed by using the set of “Fridays in December” to build the models, as opposed to the set of “public holidays in December”. A further option was treating public holidays as a special day type, but treating the days before and after also as a public holiday rather than as a separate day type.

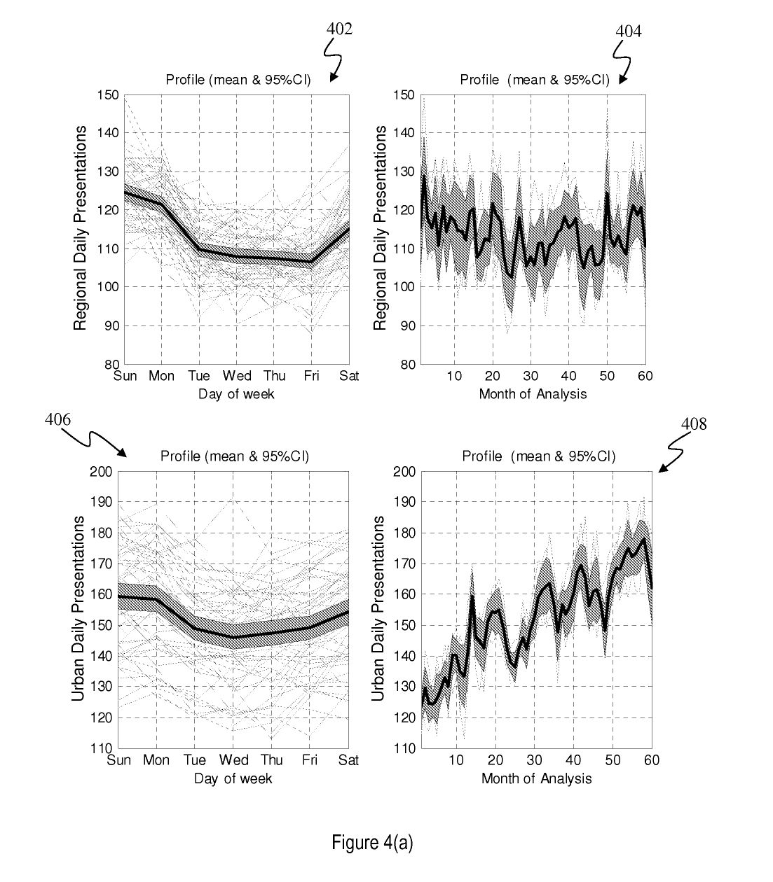

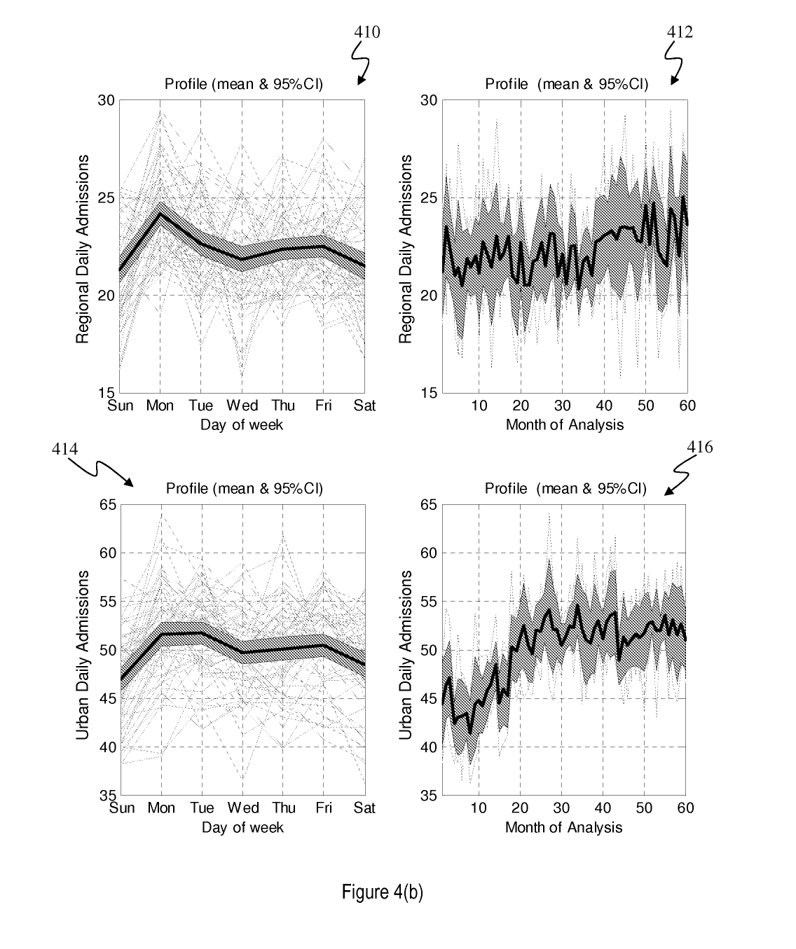

The characteristics of the test sites, as reflected in the available historical data, are shown in Table 1 and in the graphs in FIGS. 4(a) and 4(b). Analysis of the data identified the days of the week that represent higher ED workloads and hospital bed demands. The graphs 402, 404, 406, 408 of FIG. 4(a) show presentations, while the graphs 410, 412, 414, 416 of FIG. 4(b) show admissions. The graphs 402, 404, 410, 412 correspond with data from the regional facility, while the graphs 406, 408, 414, 416 correspond with the urban facility. Each pair of graphs show the mean and 95% Confidence Interval band for the days of the week (402, 406, 410, 414) and months of analysis (404, 408, 412, 416). At both hospitals, the busiest days for presentations are over the weekend and Mondays. The presentations at the regional facility were fairly stable, while the urban facility experienced an overall increase in the number of patients presenting over the five years (approximately 40% increase). Population growth over the study period was 1.3% (regional) and 3.3% (urban), which highlights the effect of the large roving population in the catchment area of the urban facility. Improvements in ARIMA forecast performance were obtained by transforming the series into stationary series by differencing (calculating successive changes in the values of a data series).

TABLE 1

| | Facility1 (Regional) | Facility2 (Urban) |
|---|---|---|
| | Mean ± 1 Standard | Mean ± 1 Standard |
| | Deviation | Deviation |
| Daily Presentations | 113 ± 14 | 152 ± 20 |
| Daily Admissions | 22 ± 5 | 50 ± 8 |
| Admission Rate | 20% ± 4% | 33% ± 5% |

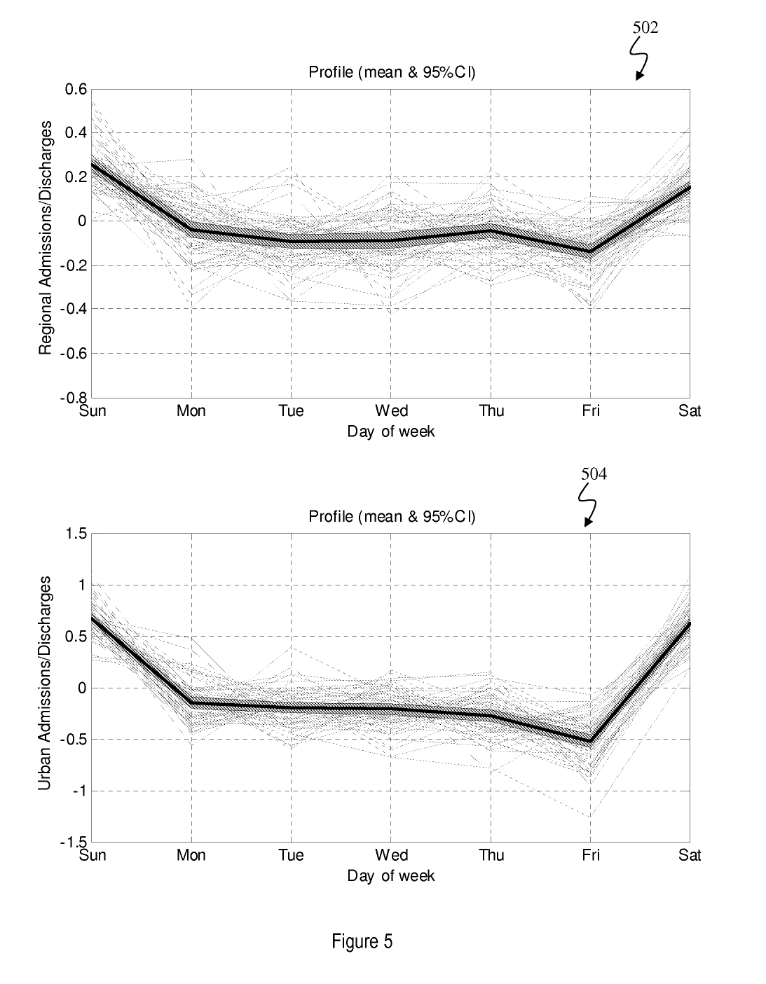

Considering the ED departure time (when patients that require admission leave the ED and are admitted to a bed), Mondays (and Tuesdays at the urban facility) are busiest (see graphs 410, 414). The data included a Length-of-Stay (LOS) field and consequently allowed the determination of when admitted patients leave hospital. Thus it was possible to obtain an understanding of patient flow for those patients that were admitted through the ED, as illustrated by the graphs 502 (regional facility) and 504 (urban facility) in FIG. 5. The mean net patient flow varies only slightly from month to month. Across a week, the weekends have a net positive patient flow, with more patients admitted than discharged. From Monday to Friday, more patients are discharged than are admitted.

As previously discussed, a number of different computational modelling methods were trialled. The best method for forecasting data in the trial study was averaging (smoothing) using as much training data as possible (four years). MAPE for predicting monthly admissions was approximately 2% at both facilities. The error for daily admissions was 16% at the regional facility and 11% at the urban facility. Corresponding results for four-hourly admissions were 47% (regional) and 40% (urban), while for hourly admissions results were 49% (regional) and 51% (urban). MAPE figures were higher in smaller time intervals (four-hourly and hourly) due to the smaller number of actual admissions. Forecast accuracy was assessed across various horizons and overall the lowest MAPE was experienced for a one-year forecast horizon. The lowest MAPE and the lowest number of forecasts outside the 95% prediction interval occurred during the busiest period, having the largest sample size.

Forecast accuracy of ED presentation data was also modelled and was found to be better than the forecast accuracy for admissions (MAPE being approximately 7% for presentation versus around 11% for admissions), likely due to the larger sample sizes. It was found that the models for presentations needed to include population growth, otherwise the estimated number of ED presentations were underestimated. This was not the case for admissions. These trends are apparent in the historical data shown in FIG. 4.

At both facilities, it was found that public holidays should be regarded as separate day types (irrespective of the actual day of week) when generating daily forecasts. This was achieved by assigning a separate code (eg Daytype=“8”) to such holidays. At a 4-hourly or hourly level, there were no significant advantages in treating public holidays as a special day type. When considering the appropriate treatment of days immediately before and after public holidays, immediately preceding and following days were most effectively treated as a public holiday at the urban facility (eg Daytype=“8”), but as a special type (eg Daytype=“9”) at the regional facility. These results suggest that consideration should be given to assigning the days before and after holidays in such a unique manner, on a facility-by-facility basis. Furthermore, it will be recognised that not all public holidays are treated equally in multicultural populations, and the model can be implemented with tailored public holiday observations.

The new forecasting models were compared to an existing prediction system available to bed managers at one of the hospitals. The existing prediction model was a simple average of the preceding two years, based on calendar position. Comparison of the study models against the existing model was made in stages due to the availability relevant reports. Results are summarised in Table 2. The MAPE across an initial evaluation period Jul. 12, 2006 to May 20, 2007 was 20.5% and 11.1% for the old and new models respectively, which represents a reduction in error of 46% across the data tested, or the equivalent of ±5 beds based on a mean admission rate of 50 admissions per day. Further analysis was performed when additional Bed Management reports became available later in the study. This data contained predictions up to January 2008, and showed that the old model had become less accurate since an additional ED opened within the hospital's catchment area. However the models embodying the present invention were less affected by this change. The MAPE across this longer evaluation period (335 days) was 30.4% and 11.8% for the old and new models respectively. This represents a 62% reduction in forecasting error, or ±9 beds based on a mean admission rate of 50 admissions per day. Multiple comparison testing has been performed on this data and shows that the differences in forecast performance are significant (one-way ANOVA with α=0.05).

TABLE 2

| | Existing | Model Predictions MAPE |
|---|---|---|
| | Predictions | (Exp smoothing, 4 yrs |
| Available Data | MAPE | training data) |
| 12 Jul. 2006-20 May 2007 | 20.5% | 11.1% |
| (n = 171 days) | | |
| 12 Jul. 2006-9 Sep. 2007 | 19.1% | 11.1% |
| (n = 261 days) | | |
| 12 Jul. 2006-20 Jan. 2008 | 30.4% | 11.8% |
| (n = 335 days) | Note effect of | |
| | opening of new | |
| | ED wing | |

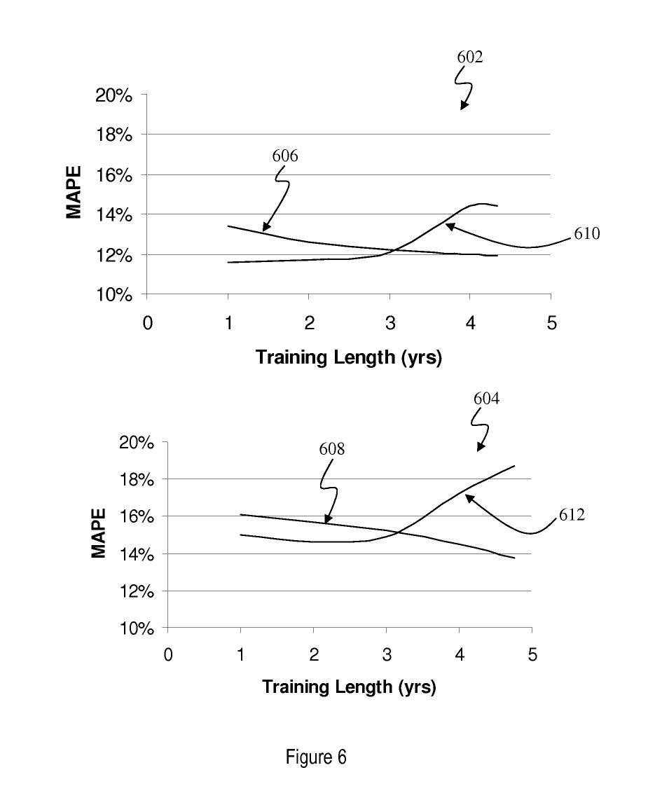

Forecast performance for the cases constructed to assess the effects of varying the length of training data is summarised in FIG. 6. The graph 602 shows MAPE as a function of the training length using data up to November 2007, at which time there was an increase in ED bed capacity within the catchment area. The graph 604 shows results using the data up to March 2008, which incorporate this change. The curves 606, 608 represent an averaging (smoothing) model, while the curves 610, 612 represent a regression model. It can be seen that averaging works best with as much data as possible (full dataset), whilst regression works best based on most recent data (one-year training data). It is also apparent that there was lower error when forecasting up to November 2007 when ED bed capacity increased in the catchment area, and that this change strongly affected accuracy of the regression model (curve 612), while only slightly reducing accuracy of the averaging model (curve 608).

A comparison of forecast performance when using training data from the same site to scaled predictions from a different site is presented in Table 3. MAPE forecasts were lower at the urban facility than at the regional facility, although the 95% prediction intervals were wider at the urban site indicating wider variation in the data. However, the results in Table 2 show that reasonably close forecasts were obtained by scaling predictions made for a different site.

TABLE 3

| | Forecasts for Facility1 (Regional) | | Forecasts for Facility2 (Urban) | |
|---|---|---|---|---|
| | 12 Months Evaluation Period | | 12 Months Evaluation Period | |
| | | Based on scaled | | Based on scaled |
| | Based on Facility1 | Facility2 | Based on Facility2 | Facility1 |
| | training data | training data | training data | training data |
| Regression MAPE | 17.0% | 18.2% | 11.0% | 14.1% |
| # days outside 95% | 19 | 1 | 12 | 89 |
| prediction interval | | | | |
| Smoothing MAPE | 16.4% | 18.3% | 11.8% | 12.4% |
| # days outside 95% | 17 | 19 | 14 | 16 |
| prediction interval | | | | |

In order to confirm that the performance of the predictive models resulted from the selective use of real historical data, a comparison was made with randomly generated data having similar statistical properties to the true historical data. Specifically, random datasets were created with the same sample size (364), mean (49.8), maximum (81), minimum (28), and standard deviation (7.69) as admissions data collected from July 2002 to June 2007. It was found that the randomly generated forecasts all had MAPE values significantly inferior to the modelled forecasts, and that it is therefore necessary to use genuine historical information, and not only the statistical characteristics of historical data, in order to obtain the best possible forecasts.

In comparing smaller datasets, eg for subgroups of patient presentations and/or admissions, it was found that forecasting performance remains roughly equivalent for sample sizes greater than 20,000 (admissions over 5 years). To forecast a particular category of interest, it was found that there needed to be roughly more than 10 admissions per day.

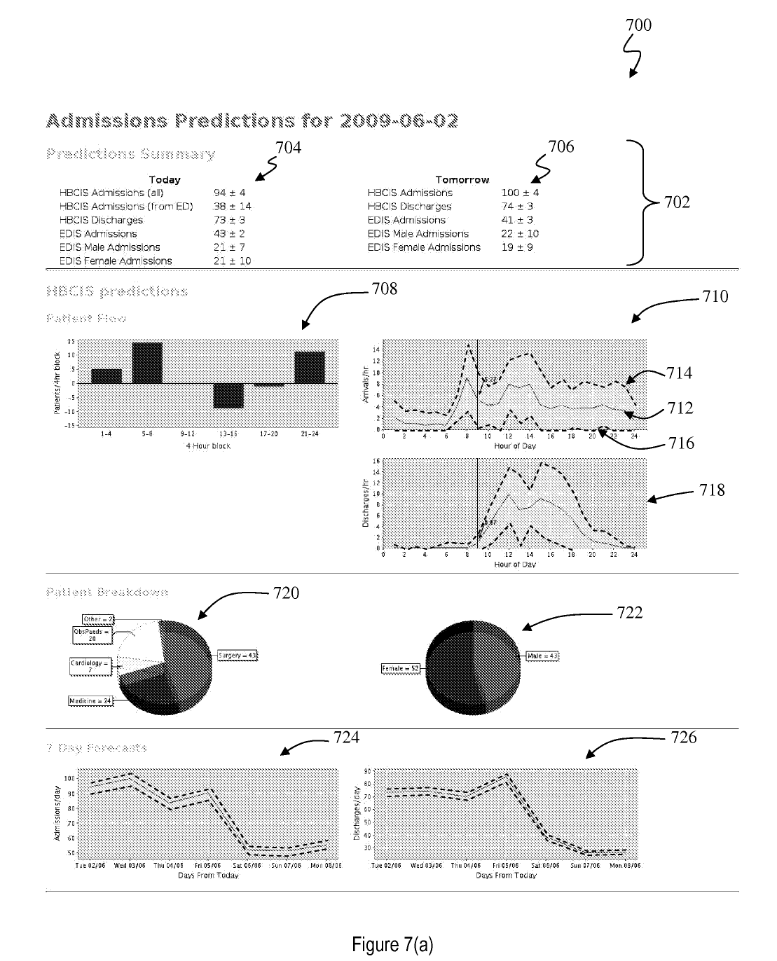

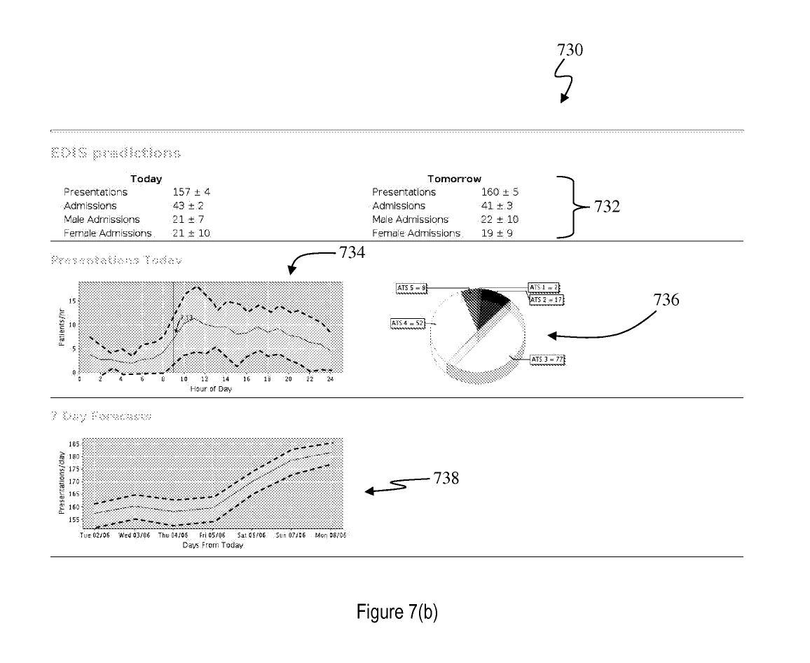

FIGS. 7(a) and 7(b) illustrate graphical displays output by an exemplary computer program embodying the invention, which has been developed in the course of the trials described above. Graphical displays of this type may be regularly and automatically updated, so that the system operates in an “unsupervised” mode, ensuring that relevant predictions are available to clinicians and other staff responsible for managing the operations of the medical facility in a form that is easy to read and apply to the management of operations.

FIG. 7(a) shows a first display portion 700 including demand prediction information. In a first section 702, a predictions summary is provided. The summary 702 includes overall predictions for today (704) and tomorrow (706). Each prediction consists of a confidence interval, at the relevant confidence level (eg as specified by the operator/user), represented as a central value, plus or minus a surrounding range. The precise detail of prediction information available will depend upon the particular medical facility, and the different information systems and departments for which predictions are provided. In the example shown in FIGS. 7(a) and 7(b) two types of predictions are included, respectively associated with a Hospital-based Computer Information System (HBCIS) and an Emergency Department Information System (EDIS).

Below the prediction summary 702 in the display portion 700 are more-detailed representations of the HBCIS predictions. These include predicted patient flow 708, represented as a bar chart broken down into four-hour time periods. A graph 710 represents predicted arrivals per hour, for each hour of the day. The graph 710 includes confidence intervals, at the relevant confidence level, represented as a central line 712, and corresponding upper- and lower-bounds 714, 716. A corresponding graph 718 shows predicted discharges per hour.

A pie chart 720 shows predicted patient breakdown for the day, with regard to the expected demand on services/departments such as surgery, medicine, cardiology and so forth. A further pie chart 722 shows the predicted breakdown between male and female patients.

Two further graphs 724, 726 show seven-day forecasts, on a daily basis, for admissions and discharges. Again, these graphs show confidence intervals, and not just a single predicted number. This information may be used, for example as a basis for determining required staffing levels over the coming week.

Turning now to the further display portion 730, in FIG. 7(b), a section 732 summarises the EDIS predictions for today and tomorrow, including predicted presentations, admissions, and a breakdown between male and female admissions. A graph 734 shows predicted presentations for today, on an hourly basis, while a pie chart 736 shows a breakdown of predicted patient criticality. Finally, a graph 738 shows the forecast for the coming seven days.

While the displays 700, 730 in FIGS. 7(a) and 7(b) have been described in the context of an automatically updated display system, it will be appreciated that some embodiments of the invention would also enable an operator to select or control the periods over which predictions are provided. For example, an interface may enable an operator to enter a specified day and/or time, and predictions such as those shown in FIGS. 7(a) and 7(b) may then be generated for the specified time period. Alternatively, or additionally, the operator may be able to force an immediate update of the display, for example by selecting a button or other user-interface element which triggers a recalculation of the predictions. In addition, while the examples described herein have utilised a 95% confidence level for the computed confidence intervals, a software implementation may enable an operator to specify an alternative confidence level, such as an 80% confidence level, an 85% confidence level, a 90% confidence level, or any other desired confidence level, which will be used for one or more subsequent calculations of predicted demand.

Other such variations will also be apparent to persons skilled in the relevant art.

It will accordingly be understood that while exemplary embodiments of the invention have been described herein, this should not be considered to limit the scope of the invention, as defined by the claims appended hereto.

1. An automated method of predicting patient demand in a medical facility during a specified time period, the method including the steps of:
providing a database containing historical data of patient demand during one or more past time periods;
associating with the specified time period at least two distinguishing characteristics, wherein a first distinguishing characteristic characterises a day within which the specified time period occurs, and a second distinguishing characteristic relates to a timeframe within which the day occurs;
extracting from the database historical patient demand data corresponding with past time periods having distinguishing characteristics equivalent to those associated with the specified time period;
applying a computational predictive model to the extracted data, to generate a prediction of patient demand during the specified time period; and
outputting the prediction of patient demand to a visual display unit, a file and/or another output device.

2. The method of claim 1 wherein the first distinguishing characteristic is a day type, which distinguishes at least between different days of the week.

3. The method of claim 2 wherein the day type further distinguishes days which are public holidays in the locality of the medical facility.

4. The method of claim 3 wherein the day type further distinguishes days immediately preceding and/or following public holidays in the locality of the medical facility.

5. The method of claim 1 wherein the second distinguishing characteristic is a month of the year within which the day occurs.

6. The method of claim 1 wherein the second distinguishing characteristic is a predetermined time period surrounding the date on which the specified time period occurs.

7. The method of claim 1 wherein the computational predictive model is one of: a multiple regression model; an Autoregressive Integrated Moving Average (ARIMA/Box-Jenkins) model; an exponential smoothing model; a uniform averaging model; and a weighted averaging model.

8. The method of claim 1 wherein the prediction of patient demand includes a prediction of patient presentations.

9. The method of claim 1 wherein the prediction of patient demand includes a prediction of patient admissions.

10. The method of claim 1 wherein the prediction of patient demand includes upper- and lower-bounds of predicted patient demand at a predetermined confidence level.

11. The method of claim 1 wherein the prediction of patient demand includes a prediction of demand by patients in one or more sub-categories.

12. The method of claim 11 wherein the sub-categories include patient gender and/or patient criticality.

13. The method of claim 1 wherein the historical data includes historical data of patient demand at the medical facility for which a prediction of patient demand is required.

14. The method of claim 1 wherein the historical data includes historical data of patient demand at one or more other medical facilities.

15. A computer-implemented system for predicting patient demand in a medical facility during a specified time period, the system including:
one or more processors;
a database, accessible to the processor(s), containing historical data of patient demand during one or more past time periods;
at least one output interface operatively associated with the processor(s); and
at least one storage medium containing program instructions for execution by the processor(s), said program instructions causing the processor(s) to execute the steps of:
associating with the specified time period at least two distinguishing characteristics, wherein a first distinguishing characteristic characterises a day within which the specified time period occurs, and a second distinguishing characteristic relates to a timeframe within which the day occurs;
extracting from the database historical patient demand data corresponding with past time periods having distinguishing characteristics equivalent to those associated with the specified time period;
computing a prediction of patient demand during the specified time period, using a predictive model based upon the extracted data;
outputting the prediction of patient demand via the output interface.

16. The system of claim 15 which includes an input interface operatively associated with the processor(s), and the program instructions further cause the processor(s) to execute the steps of:
receiving, via the input interface, updates including recent patient demand data; and
adding the recent patient demand data to the historical data contained in the database.

17. The system of claim 15 wherein the program instructions cause the processor(s) automatically to generate periodically updated predictions of patient demand.

18. The system of claim 15 which further includes a user input interface, operatively associated with the processor(s), whereby a user is able to enter a specified time period of interest, and the program instructions further cause the processor(s) to execute the steps of:
receiving the user-specified time period via the user input interface; and
generating a prediction of patient demand during the user-specified time period.

19. The system of claim 15 wherein the output interface includes a graphical display device, and the program instructions further cause the processor(s) to execute the steps of outputting a graphical display of predicted patient demand for one or more future time periods.

20. An apparatus for predicting patient demand in a medical facility during a specified time period, the apparatus including:
a database containing historical data of patient demand during one or more past time period;
means for associating with the specified time period at least two distinguishing characteristics, wherein a first distinguishing characteristic characterises a day within which the specified time period occurs, and a second distinguishing characteristic relates to a timeframe within which the day occurs;
means for extracting from the database historical patient demand data corresponding with past time period having distinguishing characteristics equivalent to those associated with the specified time period;
means for applying a computational predictive model to the extracted data to generate a prediction of patient demand during the specified time period; and
means for outputting the prediction of patient demand to a visual display unit, a file and/or other output device.

21. A computer program product including computer-executable instructions embodied upon a tangible computer-readable medium, wherein the computer-executable instructions, when executed by a suitable computer, cause the computer to implement a method according to claim 1.
